(19) United States
(12) Patent Application Publication
(10) Pub. No.: US 2026/0012741 A1
(43) Pub. Date: Jan. 8, 2026

(54) AUDIO SIGNAL PROCESSING DEVICE

(71) Applicant: ALPS ALPINE CO., LTD., Tokyo (JP)

(72) Inventors: Keita TANNO, Tokyo (JP); Kazumasa NIHIRA, Tokyo (JP)

(21) Appl. No.: 19/247,476

(22) Filed: Jun. 24, 2025

(30) Foreign Application Priority Data
Jul. 2, 2024 (JP) 2024-106767

(51) Int. Cl. H04S 7/00

(52) U.S. Cl. CPC H04S 7/30; H04S 2400/03; H04S 2420/01

(57) ABSTRACT

An audio signal processing device for downmixing surround audio signals so as to obtain a good sound image includes a pseudo surround audio signal generator for generating surround audio signals SigA of 7.1.4 channels from input 2-channel stereo audio signals SigIN, a signal processor for signal-processing the surround audio signals SigA and outputting results as downmixing signals SigB, and a downmixer for synthesizing the downmixing signals SigB and outputting 2-channel stereo audio signals SigOUT. For an input audio signal SigA of each channel, the signal processor synthesizes the audio signal and an audio signal obtained by convolving a head-related transfer function from a loudspeaker corresponding to the audio signal to a listener into the audio signal, at a ratio matching the position of the loudspeaker, and outputs the result as an audio signal SigB.

### CROSS-REFERENCE TO RELATED APPLICATION

The present application claims priority under 35 U.S.C. § 119 to Japanese Patent Application No. 2024-106767, filed Jul. 2, 2024, the contents of which are incorporated herein by reference in their entireties.

### BACKGROUND OF THE INVENTION

### Field of the Invention

The present disclosure relates to a technology for processing surround audio signals.

### Description of the Related Art

As a technology for processing surround audio signals, a technology for upmixing 2-channel stereo signals to generate 5-channel surround audio signals for C, L, R, LS, and RS is known (for example, Japanese Patent Application Laid-Open Publications No. 2013-126116 and 2010-103768).

Here, C is an audio signal for a loudspeaker in the center of a region in front of the listener, L is an audio signal for a loudspeaker on the left side in the region in front of the listener, R is an audio signal for a loudspeaker on the right side in the region in front of the listener, LS is an audio signal for a loudspeaker in the direction to the left or to the left back of the listener, and RS is an audio signal for a loudspeaker in the direction to the right or to the right back of the listener.

As a technology for processing surround audio signals, a technology for downmixing surround audio signals of multi-channels, such as 5.1 channels, to 2-channel stereo signals is known (for example, Japanese Patent Application Laid-Open Publication No. 2023-92962).

This technology convolves head-related transfer functions, which are sound transfer functions from a loudspeaker of each channel to the left and right ears of the listener respectively, into audio signals of that channel, and synthesizes such audio signals, of the respective channels, in which the head-related transfer functions are convolved, for the left and right ears separately, to thereby downmix the multi-channel audio signals to 2-channel audio signals for stereo headphones.

### SUMMARY OF THE INVENTION

When stereo 2-channel audio signals for a stereo headphone are generated by, as described above, downmixing multi-channel surround audio signals, which are audio signals of respective channels in which head-related transfer functions are convolved, the sound image in front of the frontal plane (coronal plane) dividing the body of the listener listening to the 2-channel audio signals into front and rear parts might be displaced in the upward direction or the like, or localization or staging of the sound image might become obscure, which may make it impossible to obtain a good sound image feeling.

Accordingly, an object of the present disclosure is to downmix multi-channel surround audio signals to 2-channel audio signals so as to obtain a good sound image feeling.

To achieve the object described above, an audio signal processing device of the present disclosure configured to convert surround audio signals, which include audio signals of n channels corresponding to n (where n≥4) setting positions of loudspeakers specified relatively with respect to an assumable position and an assumable aspect of a listener, the audio signals of the n channels being intended to be output to the loudspeakers set at the corresponding setting positions, into output stereo audio signals that are stereo audio signals composed of 2-channel audio signals to be output from the audio signal processing device includes:
a processor; and
a memory,
wherein the processor is configured to:
for the n channels of the surround audio signals, synthesize the audio signal of the channel concerned, and an audio signal obtained by convolving a head-related transfer function from the loudspeaker installed at the setting position corresponding to the channel concerned to the listener into the audio signal of the channel concerned, at a ratio matching the setting position corresponding to the channel concerned, to thereby output a result as a downmixing audio signal; and
generate the 2-channel audio signals of the output stereo audio signals by synthesis for including each downmixing audio signal generated.

In the audio signal processing device, the n setting positions may include a plurality of setting positions that are in front of a frontal plane of the listener and are varied in directional divergence from a direction normal to the listener. In this case, for the setting positions that are in front of the frontal plane of the listener, the ratio matching the setting position may be set such that the directionally closer the setting position is to the direction normal to the listener, a larger term of the ratio is set for the audio signal of the channel corresponding to the setting position, and a smaller term of the ratio is set for the audio signal obtained by convolving the head-related transfer function into the audio signal of the channel corresponding to the setting position.

In the audio signal processing device, the n setting positions may include a setting position in front of the frontal plane of the listener and a setting position behind the frontal plane of the listener. In this case, the ratio matching the setting position may be set such that a larger term of the ratio is set for the audio signal of the channel corresponding to the setting position and a smaller term of the ratio is set for the audio signal obtained by convolving the head-related transfer function into the audio signal of the channel corresponding to the setting position for the setting position in front of the frontal plane of the listener than for the setting position behind the frontal plane of the listener.

When the n setting positions include a setting position behind the frontal plane of the listener, for the setting position behind the frontal plane of the listener, the ratio matching the setting position may be set such that a term of 0 is set for the audio signal of the channel corresponding to the setting position, and a term of 1 is set for the audio signal obtained by convolving the head-related transfer function into the audio signal of the channel corresponding to the setting position.

In the audio signal processing device described above, the downmixing audio signals to be output by the processor for the n channels of the surround audio signals may include a left-channel downmixing audio signal and a right-channel downmixing audio signal. In this case, for the n channels of the surround audio signals, the processor may synthesize the audio signal of the channel concerned and an audio signal obtained by convolving a head-related transfer function from the loudspeaker installed at the setting position corresponding to the channel concerned to a left ear of the listener into the audio signal of the channel concerned, at a ratio matching the setting position corresponding to the channel concerned, to output a result as the left-channel downmixing audio signal, and may synthesize the audio signal of the channel concerned and an audio signal obtained by convolving a head-related transfer function from the loudspeaker installed at the setting position corresponding to the channel concerned to a right ear of the listener into the audio signal of the channel concerned, at a ratio matching the setting position corresponding to the channel concerned, to output a result as the right-channel downmixing audio signal. Further, the processor may generate a left-channel audio signal of the output stereo audio signals by synthesis for including each left-channel downmixing audio signal generated, and may generate a right-channel audio signal of the output stereo audio signals by synthesis for including each right-channel downmixing audio signal generated.

In this case, the surround audio signals may include an audio signal for low-tone reproduction of a low-frequency effect channel, and the processor may synthesize each left-channel downmixing audio signal generated, with the audio signal of the low-frequency effect channel to generate the left-channel audio signal of the output stereo audio signals, and may synthesize each right-channel downmixing audio signal generated, with the audio signal of the low-frequency effect channel to generate the right-channel audio signal of the output stereo audio signals.

In the audio signal processing device, the processor may further be configured to generate the surround audio signals from input stereo audio signals, which are stereo audio signals composed of 2-channel audio signals input into the audio signal processing device.

According to such an audio signal processing device, it is possible to generate downmixing audio signals, which are the sources to be downmixed to the output stereo audio signals, by making the contribution of the head-related transfer function lower in an audio signal to be output to a loudspeaker installed at a setting position in front of the listener, that is assumable based on the frontal plane, than in an audio signal to be output to a loudspeaker installed otherwise. Thus, it is possible to inhibit the position at which a sound image in front of the frontal plane (coronal plane) is to be localized from being displaced from the intended position due to the application of the head-related transfer function. In addition, along with this, it is possible to inhibit localization and staging of the sound image from becoming obscure.

As described above, according to the present disclosure, it is possible to downmix multi-channel surround audio signals to 2-channel audio signals so as to obtain a good sound image feeling.

### BRIEF DESCRIPTION OF THE DRAWINGS

FIG. 1 is a diagram showing the configuration of an audio signal processing device according to an embodiment of the present disclosure;

FIG. 2A is a diagram showing loudspeaker arrangement assumed in an embodiment of the present disclosure;

FIG. 2B is a diagram showing loudspeaker setting assumed in an embodiment of the present disclosure;

FIG. 3 is a diagram showing the configuration of a component separation unit that can be used in a pseudo surround audio signal generator according to an embodiment of the present disclosure;

FIG. 4 is a diagram showing the configuration of a downmixing signal generator according to an embodiment of the present disclosure;

FIG. 5A is a diagram showing an example of how to set a head-related transfer function contribution ratio according to an embodiment of the present disclosure; and

FIG. 5B is a diagram showing an example of how to set a head-related transfer function contribution ratio according to an embodiment of the present disclosure.

### DETAILED DESCRIPTION OF THE DISCLOSURE

Embodiments of the present disclosure will be described below.

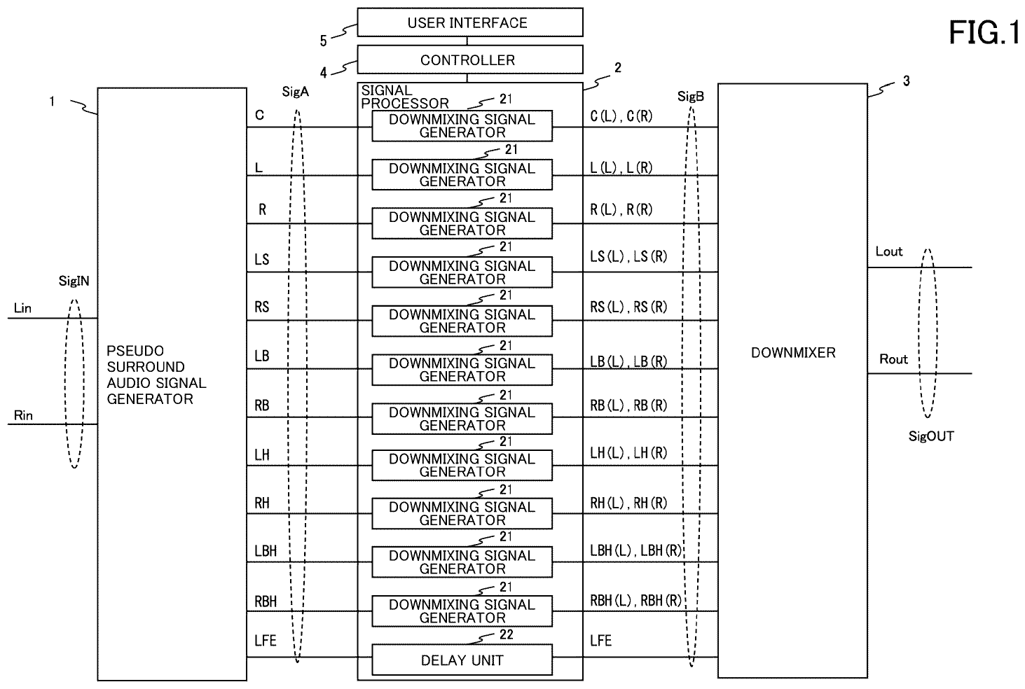

FIG. 1 shows the configuration of an audio signal processing device according to the present embodiment.

As shown in the diagram, the audio signal processing device includes: a pseudo surround audio signal generator 1 configured to upmix input Lin and Rin 2-channel stereo signals SigIN to generate 7.1.4-channel surround audio signals SigA composed of C, L, R, LS, RS, LB, RB, LFE, LH, RH, LBH, and RBH audio signals; a signal processor 2 configured to process the surround audio signals SigA generated by the pseudo surround audio signal generator 1 to output C(L), C(R), L(L), L(R), R(L), R(R), LS(L), LS(R), RS(L), RS(R), LB(L), LB(R), RB(L), RB(R), LH(L), LH(R), RH(L), RH(R), LBH(L), LBH(R), RBH(L), RBH(R), and LFE signals as downmixing signals SigB; a downmixer 3 configured to synthesize the downmixing signals SigB to output Lout and Rout 2-channel stereo signals SigOUT; a controller 4; and a user interface 5, such as a switch, a touch panel, or the like configured to receive user operations.

Here, the downmixer 3 generates the Lout by synthesizing C(L), L(L), R(L), LS(L), RS(L), LB(L), RB(L), LH(L), RH(L), LBH(L), RBH(L), and LFE while applying appropriate gains and delays to them, and generates the Rout by synthesizing C(R), L(R), R(R), LS(R), RS(R), LB(R), RB(R), LH(R), RH(R), LBH(R), RBH(R), and LFE while applying appropriate gains and delays to them.

The pseudo surround audio signal generator 1, the signal processor 2, the downmixer 3, and the controller 4 are composed of an electronic circuit (including a processor), such as a Central Processing Unit (CPU), a Graphics Processing Unit (GPU), a Digital Signal Processor (DSP), a Field Programmable Gate Array (FPGA), an Application Specific Integrated Circuit (ASIC), and the like, and are configured to perform various processes described herein by executing instruction codes stored in a memory or by being designed as a circuit for a specific application.

The stereo signals SigOUT output by the downmixer 3 are 2-channel stereo signals to be output from an audio output device equipped with a left and right pair of loudspeakers, such as a pair of stereo headphones, a pair of stereo earphones, and the like. The Lout is an audio signal of the left (L) channel and the Rout is an audio signal of the right (R) channel.

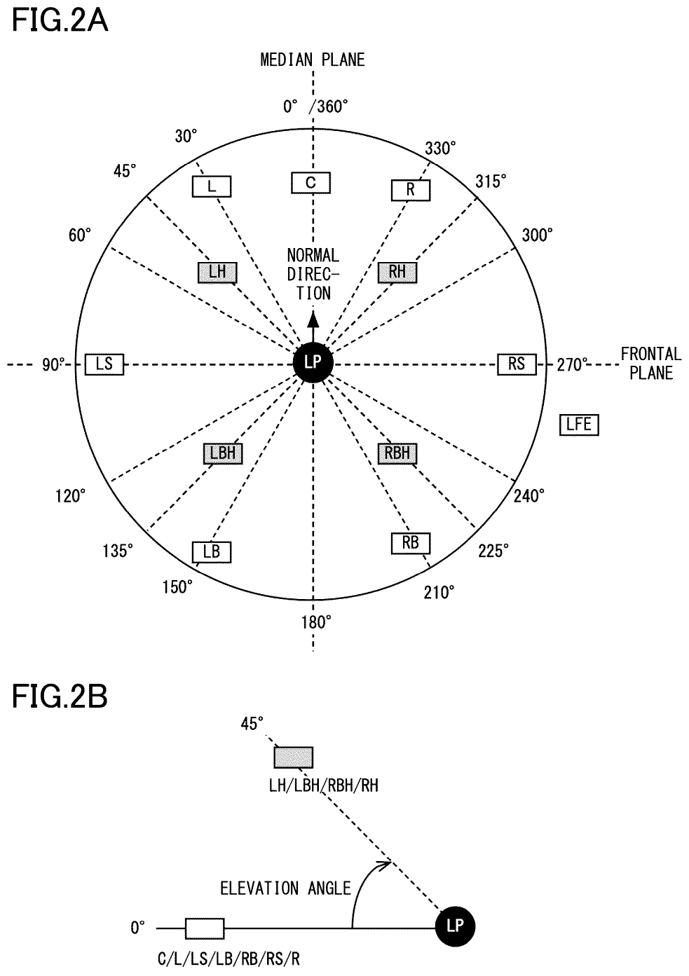

Each audio signal of the surround audio signals SigA is a surround audio signal that is assumed to be output by using loudspeakers that are set at, for example, twelve positions shown in FIGS. 2A and 2B.

However, since the audio signal LFE is an audio signal of the low-frequency effect channel and no sound image of the low-tone audio signal of the low-frequency effect channel localizes, the setting position of a low-tone subwoofer, which is the loudspeaker corresponding to the signal LFE, may be desirably set.

In the illustrated example, as shown in FIG. 2A, assuming that the horizontal angles are measured counterclockwise in a vertically downward perspective while regarding the direction normal to the listener, seen from the listening point LP of the listener, to be at a horizontal angle of 0°, the loudspeaker corresponding to C is set at a horizontal angle of 0°, the loudspeaker corresponding to L is set at a horizontal angle of 30°, the loudspeaker corresponding to R is set at a horizontal angle of 330°, the loudspeaker corresponding to LS is set at a horizontal angle of 90°, the loudspeaker corresponding to RS is set at a horizontal angle of 270°, the loudspeaker corresponding to LB is set at a horizontal angle of 150°, the loudspeaker corresponding to RB is set at a horizontal angle of 210°, the loudspeaker corresponding to LH is set at a horizontal angle of 45°, the loudspeaker corresponding to RH is set at a horizontal angle of 315°, the loudspeaker corresponding to LBH is set at a horizontal angle of 135°, and the loudspeaker corresponding to RBH is set at a horizontal angle of 225°.

In the illustrated example, as the elevation angle of the setting position of each loudspeaker being shown in FIG. 2B, the loudspeakers corresponding to C, L, R, LS, RS, LB, and RB are set at an elevation angle of 0° when seen from the listening point LP of the listener, and the loudspeakers corresponding to LH, RH, LBH and RBH are set at an elevation angle of 45° when seen from the listening point LP of the listener.

The specific configuration for generation of the surround audio signals SigA by the pseudo surround audio signal generator 1 has variety depending on the application and the like. Yet, basically, it is possible to generate each audio signal of the surround audio signals SigA by separating, from the Lin and Rin stereo signals SigIN, the component of Lin correlated with Rin, the component of Lin uncorrelated with Rin, the component of Rin correlated with Lin, and the component of Rin uncorrelated with Lin, and combining the components separated, or combining the components with Lin and Rin.

For example, LFE of the surround audio signals SigA generated by the pseudo surround audio signal generator 1 can be generated as the sum of the low-tone components of Lin and Rin.

Further, LS can be generated as the component of Lin uncorrelated with Rin, RS can be generated as the component of Rin uncorrelated with Lin, C can be generated as the sum of the components of Lin and Rin correlated with the other of Lin and Rin, L can be generated as the sum of LS and C, and R can be generated as the sum of RS and C.

LB can be generated by synthesizing delayed Lin, L, LS, and C at an appropriate mixing ratio, and RB can be generated by synthesizing delayed Rin, R, RS, and C at an appropriate mixing ratio.

LH can be generated by applying appropriate delay and reverb effects to L, RH can be generated by applying appropriate delay and reverb effects to R, LBH can be generated by applying appropriate delay and reverb effects to LB, and RBH can be generated by applying appropriate delay and reverb effects to RB.

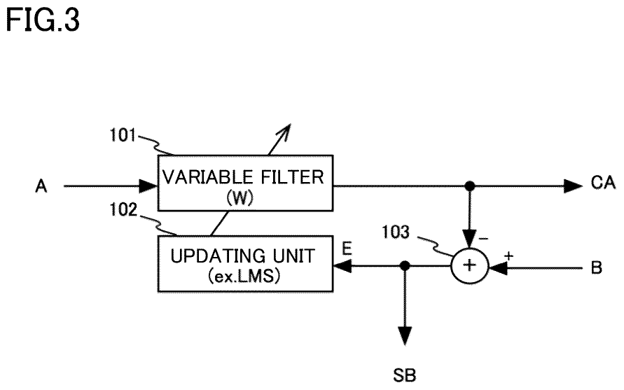

Separation of correlated and uncorrelated components can be performed, for example, by using a component separation unit having the configuration shown in FIG. 3.

The component separation unit shown in FIG. 3 is configured to separate a component CA of a signal B correlated with a signal A and a component SB of the signal B uncorrelated with the signal A from the signal A and the signal B.

As shown in the drawing, the component separation unit includes a variable filter 101, an update unit 102 configured to update the transfer function (filter coefficient) W of the variable filter 101 by an adaptive algorithm, such as an LMS algorithm and the like, and an adder 103. The variable filter 101, the update unit 102, and the adder 103 constitute an adaptive filter.

The variable filter 101 receives the signal A as an input, and the adder 103 subtracts the output from the variable filter 101 from the signal B and outputs the result. The update unit 102 executes the adaptive algorithm by regarding the output from the adder 103 as an error, to update the transfer function W of the variable filter 101 such that the power of the error becomes minimum.

The power of the output from the adder 103 becomes minimum when the output from the variable filter 101 coincides with the component CA of the signal B correlated with the signal A. This is when the output from the adder 103 obtained by subtracting the output from the variable filter 101 from the signal B represents the component SB of the signal B uncorrelated with the signal A.

Therefore, the component CA of the signal B correlated with the signal A can be separated as the output from the variable filter 101, and the component SB of the signal B uncorrelated with the signal A can be separated as the output from the adder 103. By exchanging the signal B with the signal A, it is possible to separate the component CB of the signal A correlated with the signal B and the component SA of the signal A uncorrelated with the signal B similarly.

Referring back to FIG. 1, the signal processor 2 includes: downmixing signal generators 21 that are provided correspondingly to the audio signals C, L, R, LS, RS, LB, RB, LH, RH, LBH, and RBH of the surround audio signals SigA and to which the corresponding audio signals are input; and a delay unit 22 to which the audio signal LFE is input.

The downmixing signal generator 21 to which the audio signal X (where X is one of C, L, R, LS, RS, LB, RB, LH, RH, LBH, or RBH) is input performs signal processing on the audio signal X, to generate audio signals X(L) and X(R) of the downmixing signals SigB, and outputs them to the downmixer 3.

The delay unit 22 delays the audio signal LFE as much as the processing delay in the downmixing signal generators 21, and outputs the result to the downmixer 3.

Now, each of the downmixing signal generators 21 of the signal processor 2 will be described.

Since the downmixing signal generators 21 of the signal processor 2 have similar configurations, the configuration of the downmixing signal generator 21 corresponding to the audio signal LH will be described below as a representative example.

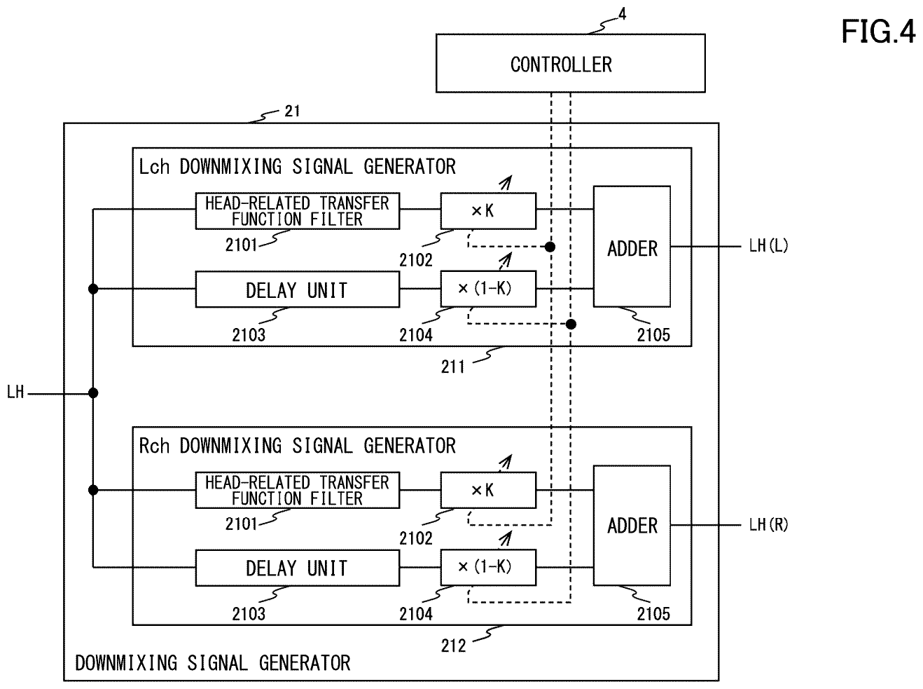

FIG. 4 shows the configuration of the downmixing signal generator 21 corresponding to the audio signal LH, and the downmixing signal generator 21 includes an Lch downmixing signal generator 211 and an Rch downmixing signal generator 212.

The Lch downmixing signal generator 211 and the Rch downmixing signal generator 212 each include a head-related transfer function filter 2101 into which the audio signal LH is input, a K-times multiplier 2102 for multiplying the output from the head-related transfer function filter 2101 by K, a delay unit 2103 for delaying the audio signal LH such that the delay coincides with the output from the head-related transfer function filter 2101, a (1−K)-times multiplier 2104 for multiplying the audio signal LH delayed by the delay unit 2103 by (1−K), and an adder 2105 for adding the output from the K-times multiplier 2102 and the output from the (1−K)-times multiplier 2104 and outputting the result.

In the head-related transfer function filter 2101 of the Lch downmixing signal generator 211, a sound transfer function from the loudspeaker corresponding to the audio signal LH to the left ear of the listener is set as the head-related transfer function, and the head-related transfer function filter 2101 outputs a result obtained by convolving the head-related transfer function that is set for the input audio signal LH in the input audio signal LH. The adder 2105 of the Lch downmixing signal generator 211 outputs its output as LH(L) of the downmixing signals SigB to the downmixer 3.

In the head-related transfer function filter 2101 of the Rch downmixing signal generator 212, a sound transfer function from the loudspeaker corresponding to the audio signal LH to the right ear of the listener is set as the head-related transfer function, and the head-related transfer function filter 2101 outputs a result obtained by convolving the head-related transfer function that is set for the input audio signal LH in the input audio signal LH. The adder 2105 of the Rch downmixing signal generator 212 outputs its output as LH(R) of the downmix signals SigB to the downmixer 3.

In the same downmixing signal generator 21, the multipliers K of the K-times multipliers 2102 of the Lch downmixing signal generator 211 and the Rch downmixing signal generator 212 are equal to each other, and the multipliers (1−K) of the (1−K)-times multipliers 2104 of the Lch downmixing signal generator 211 and the Rch downmixing signal generator 212 are equal to each other. These multipliers are values set by the controller 4 and there is a relationship 0≤K≤1.

The outputs from the adders 2105 of the Lch downmixing signal generator 211 and the Rch downmixing signal generator 212 are audio signals resulting from an audio signal obtained by convolving the head-related transfer function in the audio signal LH and the audio signal LH being mixed at the ratio K:(1−K). Therefore, K represents the contribution ratio of the head-related transfer function in the LH(L) and the LH(R) that are output to the downmixer 3. Therefore, in the following description, K is referred to as the head-related transfer function contribution ratio K.

Note that the downmixing signal generators 21 corresponding to the audio signals C, L, R, LS, RS, LB, RB, RH, LBH, and RBH also have configurations similar to that of the downmixing signal generator 21 corresponding to the LH. They can be described by replacing the sign LH in the configuration of the downmixing signal generators 21 corresponding to LH shown in FIG. 4 and the sign LH in the above description of the downmixing signal generator 21 corresponding to LH with corresponding audio signals.

However, the head-related transfer function contribution ratios K set by the controller 4 in the respective downmixing signal generators 21 are not the same, and values matching the downmixing signal generators 21 are set.

The controller 4 sets the head-related transfer function contribution ratio K to be set in each downmixing signal generator 21, in accordance with the horizontal angle, shown in FIG. 2A, of the loudspeaker corresponding to the audio signal input into the downmixing signal generator.

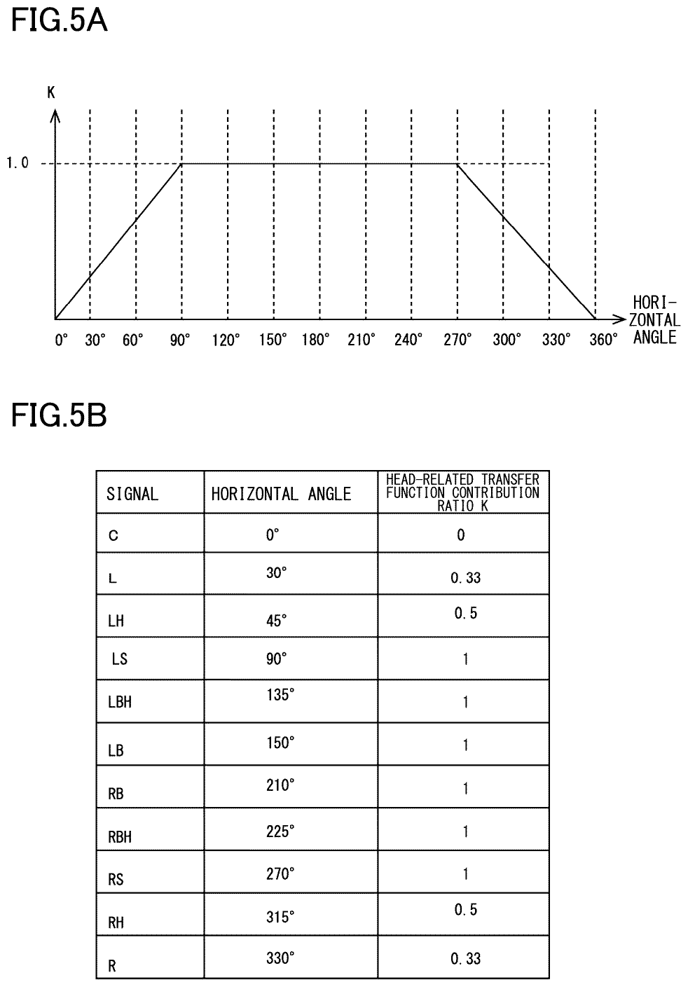

FIG. 5A shows the relationship between the horizontal angle of the loudspeaker and the head-related transfer function contribution ratio K to be set. The head-related transfer function contribution ratio K is set such that the head-related transfer function contribution ratio K is closer to 0 at a horizontal angle closer to the normal direction (0°/360°) of the listener in the horizontal angle ranges (0°-90°, 270°-360°) in front of the listener's frontal plane (i.e., a plane of which the normal is in a direction at a horizontal angle of 0° and an elevation angle of) 0°, and the head-related transfer function contribution ratio K is 1 at the horizontal angles not in front of the listener's frontal plane.

FIG. 5B shows the head-related transfer function contribution ratio K set in the downmixing signal generators 21 corresponding to the audio signals C, L, R, LS, RS, LB, RB, LH, RH, LBH, and RBH of the surround audio signals SigA in accordance with the relationship shown in FIG. 5A. The head-related transfer function contribution ratio K set in the downmixing signal generator 21 corresponding to C is 0, the head-related transfer function contribution ratio K set in the downmixing signal generators 21 corresponding to L and R is 0.33, the head-related transfer function contribution ratio K set in the downmixing signal generators 21 corresponding to LH and RH is 0.5, and the head-related transfer function contribution ratio K set in the downmixing signal generators 21 corresponding to all of the remaining LS, RS, LB, RB, LBH, and RBH is 1.

As a result, among the audio signals as the downmixing signals SigB that are to be input into the downmixer 3 and synthesized into the 2-channel stereo signals Lout and Rout, the audio signals corresponding to the loudspeakers that are not in front of the listener's frontal plane are the head-related transfer function-convolved versions of the audio signals, corresponding to these loudspeakers, among the surround audio signals SigA, except for LFE. On the other hand, the audio signals corresponding to the loudspeakers that are in front of the listener's frontal plane are the mix of the audio signals, corresponding to these loudspeakers, among the surround audio signals SigA, with the head-related transfer function-convolved versions of these audio signals, except for LFE, with the mixed head-related transfer function-convolved audio signals accounting for smaller ratios in the audio signals corresponding to the loudspeakers closer to the normal direction of the listener.

As a result, it is possible to inhibit the position at which a sound image in front of the frontal plane is to be localized from being displaced from the intended position in the upward direction or the like due to the application of the head-related transfer function. In addition, along with this, it is possible to inhibit localization and staging of the sound image from becoming obscure.

Here, the controller 4 also has a function of individually changing the head-related transfer function contribution ratio K to be set in each downmixing signal generator 21 in accordance with a user operation received via the user interface 5. Thus, with the head-related transfer function contribution ratio K allowed to be changed and adjusted in accordance with a user operation, each user can adjust the characteristics of the sound image localization in accordance with his/her own taste and feeling.

Thus, the embodiment of the present disclosure has been explained.

In the above-described embodiment, for the horizontal angles of the loudspeakers corresponding to the audio signals input into the downmixing signal generators 21 that are the horizontal angles in front of the listener's frontal plane, the closer the horizontal axis is to the normal direction (0°/360°) of the listener, the closer the head-related transfer function contribution ratio K is set to 0. However, the same value may be used as the head-related transfer function contribution ratio K in all of the downmixing signal generators 21 into which the audio signals corresponding to the loudspeakers that are set at the horizontal angles in front of the listener's frontal plane are input. However, as this same value, a value smaller than the head-related transfer function contribution ratio K of the downmixing signal generators 21 into which the audio signals, the loudspeakers corresponding to which are set at the horizontal angles not in front of the listener's frontal plane, are input is used.

In the above embodiments, the pseudo surround audio signal generator 1 generates the 7.1.4-channel surround audio signals. However, the pseudo surround audio signal generator 1 may generate the surround audio signals SigA of L.0.0 channels, L.1.0 channels, L.0.M channels, and L.1.M channels where L is an arbitrary number equal to or greater than 4 and M is an arbitrary number equal to or greater than 2, and the signal processor 2 and the downmixer 3 may perform the above-described processing for each audio signal of the surround audio signals SigA in a form adapted to these audio signals.

Moreover, the pseudo surround audio signal generator 1 may be omitted, and audio signals of the surround audio signals SigA of L.0.0 channels, L.1.0 channels, L.0.M channels, and L.1.M channels may be input into the signal processor 2 as the audio source, and the signal processor 2 and the downmixer 3 may perform the above-described processing in a form adapted to these audio signals.

What is claimed is:

1. An audio signal processing device configured to convert surround audio signals, which include audio signals of n channels corresponding to n (where n≥4) setting positions of loudspeakers specified relatively with respect to an assumable position and an assumable aspect of a listener, the audio signals of the n channels being intended to be output to the loudspeakers set at the corresponding setting positions, into output stereo audio signals that are stereo audio signals composed of 2-channel audio signals to be output from the audio signal processing device, the audio signal processing device comprising:
a processor; and
a memory,
wherein the processor is configured to:
for the n channels of the surround audio signals, synthesize the audio signal of the channel concerned, and an audio signal obtained by convolving a head-related transfer function from the loudspeaker installed at the setting position corresponding to the channel concerned to the listener into the audio signal of the channel concerned, at a ratio matching the setting position corresponding to the channel concerned, to thereby output a result as a downmixing audio signal; and
generate the 2-channel audio signals of the output stereo audio signals by synthesis for including each downmixing audio signal generated.

2. The audio signal processing device according to claim 1,
wherein the n setting positions include a plurality of setting positions that are in front of a frontal plane of the listener and are varied in directional divergence from a direction normal to the listener, and
for the setting positions that are in front of the frontal plane of the listener, the ratio matching the setting position is set such that the directionally closer the setting position is to the direction normal to the listener, a larger term of the ratio is set for the audio signal of the channel corresponding to the setting position, and a smaller term of the ratio is set for the audio signal obtained by convolving the head-related transfer function into the audio signal of the channel corresponding to the setting position.

3. The audio signal processing device according to claim 1,
wherein the n setting positions include a setting position in front of a frontal plane of the listener and a setting position behind the frontal plane of the listener, and
wherein the ratio matching the setting position is set such that a larger term of the ratio is set for the audio signal of the channel corresponding to the setting position and a smaller term of the ratio is set for the audio signal obtained by convolving the head-related transfer function into the audio signal of the channel corresponding to the setting position for the setting position in front of the frontal plane of the listener than for the setting position behind the frontal plane of the listener.

4. The audio signal processing device according to claim 2,
wherein the n setting positions include a setting position behind the frontal plane of the listener, and
wherein for the setting position behind the frontal plane of the listener, the ratio matching the setting position is set such that a term of 0 is set for the audio signal of the channel corresponding to the setting position, and a term of 1 is set for the audio signal obtained by convolving the head-related transfer function into the audio signal of the channel corresponding to the setting position.

5. The audio signal processing device according to claim 1,
wherein the downmixing audio signals to be output by the processor for the n channels of the surround audio signals include a left-channel downmixing audio signal and a right-channel downmixing audio signal,
wherein for the n channels of the surround audio signals, the processor synthesizes the audio signal of the channel concerned and an audio signal obtained by convolving a head-related transfer function from the loudspeaker installed at the setting position corresponding to the channel concerned to a left ear of the listener into the audio signal of the channel concerned, at a ratio matching the setting position corresponding to the channel concerned, to output a result as the left-channel downmixing audio signal, and synthesizes the audio signal of the channel concerned and an audio signal obtained by convolving a head-related transfer function from the loudspeaker installed at the setting position corresponding to the channel concerned to a right ear of the listener into the audio signal of the channel concerned, at a ratio matching the setting position corresponding to the channel concerned, to output a result as the right-channel downmixing audio signal, and
wherein the processor generates a left-channel audio signal of the output stereo audio signals by synthesis for including each left-channel downmixing audio signal generated, and generates a right-channel audio signal of the output stereo audio signals by synthesis for including each right-channel downmixing audio signal generated.

6. The audio signal processing device according to claim 5,
wherein the surround audio signals include an audio signal for low-tone reproduction of a low-frequency effect channel,
wherein the processor synthesizes each left-channel downmixing audio signal generated, with the audio signal of the low-frequency effect to generate the left-channel audio signal of the output stereo audio signals, and synthesizes each right-channel downmixing audio signal generated, with the audio signal of the low-frequency effect channel to generate the right-channel audio signal of the output stereo audio signals.

7. The audio signal processing device according to claim 1,
wherein the processor is further configured to:
generate the surround audio signals from input stereo audio signals, which are stereo audio signals composed of 2-channel audio signals input into the audio signal processing device.
